(19) United States
(12) Patent Application Publication
(10) Pub. No.: US 2016/0220974 A1
(43) Pub. Date: Aug. 4, 2016

(54) MOBILE DEVICE FOR FILLING TUBULAR CATALYTIC REACTORS

(71) Applicant: SANINORD, Loon Plage (FR)

(72) Inventor: Christian SCHMIDT, Hoerdt (FR)

(73) Assignee: SANINORD, Loon Plage (FR)

(21) Appl. No.: 15/021,013

(22) PCT Filed: Sep. 10, 2014
(86) PCT No.: PCT/FR2014/052237

§ 371 Date: Mar. 10, 2016

(30) Foreign Application Priority Data
Sep. 10, 2013 (FR) 1358704

(51) Int. Cl. B01J 8/00

(52) U.S. Cl. CPC B01J 8/003; B01J 2208/00752

(57) ABSTRACT

A mobile device for filling at least one tube of a catalytic reactor consisting of a plurality of parallel tubes filled with a catalyst in a granular form. The device is characterised in that it includes: a catalyst storage trough with a sieve-type bottom, each hole of said bottom corresponding to a tube of the reactor; a catalyst dosing system for each tube to be filled; and means for the simultaneous release of the catalyst contained in the dosing system towards the at least one tube to be filled.

The invention relates to a mobile device for filling at least one tube (1) of a catalytic reactor consisting of a plurality of parallel tubes (1) filled with a catalyst (9) in a granular form. Said device is characterised in that it comprises: a catalyst storage trough (2) with a sieve-type bottom (34), each hole of said bottom corresponding to a tube (1) of the reactor; a catalyst (9) dosing system (3) for each tube (1) to be filled; and means for the simultaneous release of the catalyst (9) contained in the dosing system (3) towards the at least one tube (1) to be filled.

### TECHNICAL FIELD OF THE INVENTION

The present invention relates to a device for filling tubes of a catalytic reactor consisting of a plurality of tubes with a parallel aspect, these tubes being finally filled with a catalyst found in a granular form.

Catalytic reactors concerned by the invention consist of several thousands of tubes provided vertically, and which have the particularity of having a significant length relatively to their diameter, typically with a ratio which may be of the order of 100 or more. These are therefore long and thin tubes.

According to a dimensional example which may be encountered in practice, the tubes may have a diameter of the order of 20 to 50 mm for a length of more than 2 m. They are therefore filled with a catalytic material in granular form, sometimes with a spherical aspect, sometimes with a rather cylindrical aspect or with an indistinct form for which the dimensions are in any case of the order of 5 to 10 mm, or even a little more for the larger ones. These granules are of a more or less fragile constitution depending on their shapes and on their compositions.

The use of such catalytic reactors is very widespread in the chemical industry, where for example they are used in the synthesis of ammonia, for making nitric acid, sulfuric acid, acrylic acid, formol, as well as in petrochemistry.

In order to guarantee operation of the reactor, it is necessary to proceed with emptying of the beads or granules according to a regular periodicity. In this case each tube has to be emptied of the used granular material, in order to result in fine in an emptying of the totality of the reactor, during a so called unloading operation of the catalyst. The reactor is then subject to an operation for filling with new catalytic material granules during a loading operation.

The loading of the tubes, has many constraints. Achieving it is first tedious since the number of tubes to be loaded is very large, involving repetitive operations because of this large number. Now, loading a tube is not a simple task, as this will be seen subsequently. Finally, in spite of the difficulty inherent to this operation, the time factor is important.

The operations for unloading and loading catalysts actually require stops for maintenance of production lines, which have to be as short as possible for obvious economical reasons.

Moreover, considering the chemical or physical natures of the catalysts, often consisting of heavy metals, it is imperative to prevent, or at the very least limit as much as possible the generation and dispersion of dusts so that the operators are not or very slightly exposed to them.

The dimensions of the granules or beads of catalysts being significant relatively to said diameters, one of the main problems lies in the fact that the granules may be jammed and form plugs regardless of the selected loading solution. The problem is not less in cases when, for optimizing the operation of reactors, several layers of different nature of granular material may be stacked in each tube, with decreasing granule dimensions from the upper layer to the lower layer.

In essence, loading granules having the mentioned dimensions in long and thin tubes within a reasonable time without degrading them and without untimely discharges of dusts is unquestionably a difficult operation.

### PRIOR ART

One of the preferentially used solutions until now consisted in setting up machines for loading 5, 10 or 20 tubes. These machines, relatively bulky, had as many compartments as there are tubes to be filled, i.e. 10 for example. In each compartment, the operator places a predefined catalyst dose, exactly corresponding to the amount of catalyst to be poured into a tube. In parallel, funnels connected to each compartment via a flexible pipe are plugged into the tubes of the reactor to be filled. Finally, the operator activates unloading of the catalyst which, by means of a vibratory system, makes its way from the compartment to the pipe, and then to the funnel, and finally into the tube of the reactor, and this within a given time.

The making and the handling of the doses, the progression of the catalyst through the pipes and the funnels, and the repetition of the operations makes the quality of this loading method random.

A machine of the prior art as described, requires a supporting surface on the ground extending over about 400 tubes for only filling 10 tubes, The bulkiness of these machines is so large that it is difficult to simultaneously fill more than 30 tubes of a reactor.

Another way for loading the catalyst in the tubes according to the prior art consists of inserting loading sleeves into the tubes to be filled. This type of sleeve has a length calculated according to the desired filling height of a tube, a diameter of less than that of a tube, and is provided with an upper flange (with a calibrated passage hole) resting on a tubular plate surrounding the tube. The operators spread the catalyst directly on the ground, so as to fill the sleeves to the brim by means of hand brushes. The sleeves are then removed from the tubes, and then reintroduced into the tubes so as to check the loading height of catalyst in the tubes. This device has the drawback of producing a lot of dust during the handling of the catalyst during the filling of the sleeves with the hand brushes. Further, emptying the sleeves is tedious, and only bead-shaped granules may be loaded with this method.

### INVENTION

The invention, globally finding a remedy to the mentioned drawbacks, proposes a solution for which application is easy, accessible to any type of reactor, allowing fast and efficient loading, and wherein the problem of dust and degradation of the catalyst are managed.

For this purpose, the device of the invention consists in a mobile filling device capable of filling at least one tube of a catalytic reactor consisting of a plurality of tubes with a parallel aspect filled with a catalyst found in granular form. This device includes:
a catalyst storage trough with a sieve-shaped bottom, each hole of which is able to coincide with a tube of the reactor;
a catalyst dosing system for each tube to be filled, corresponding to a dosing column capable of being centered relatively to the tube and receiving a predetermined catalyst volume;
means for simultaneously releasing the catalyst contained in the dosing system towards the tube(s) to be filled.

The device of the invention is mainly characterized in that it has means for recovering the dust formed by the pouring of the catalyst into the tubes. Indeed, it is at the junction between the dosing columns and the tubes where dust is mainly generated. These means for recovering the dust will be described in detail in the following description.

The device of the invention allows filling of one or several tubes. Preferably, the device is provided for filling for example 1, 3, 20 or 100 tubes simultaneously, so as to cover as efficiently as possible the circular surface or a sector of the circular surface of a catalytic reactor, the device for 100 tubes being provided for filling central areas, and the devices 1, 3 and 20 being provided for filling the perimeters of the sector.

Such a device may also be easily dimensioned for filling more than 100 tubes simultaneously.

This dosing system gives the possibility of avoiding the pre-dosing step usually carried out during the use of the machines of the prior art. Indeed, it is no longer necessary to issue specific doses of catalyst for each tube. It is sufficient to pour a non-measured amount of catalyst directly into the storage trough, and to spread it out in the dosing columns. When a dosing column is filled to the brim, this means that the catalyst volume required for a tube is present in the column, and may be poured therein. It is possible to repeat the operation n times for example if the equivalent of n dosing columns should be poured into a tube. This allows limitation of the bulkiness in height of the machine, so that it is compatible with all types of reactors.

In order to determine the volume of catalyst to be poured into a tube, it is sufficient to perform a simple conversion between the heights for filling the tube and those of the dosage column. In practice, the desired filling height of a tube is known, and also its diameter. It is therefore easy to determine the desired volume of catalyst per tube. Knowing this volume and the diameter of a dosing column, it is therefore easy to know the height to be filled of the dosing column, so that the exact catalyst volume is present therein. For this purpose, the mobile device according to the invention comprises means for adjusting in height the dosing column depending on the volume of catalyst to be dosed. After adjusting the height of the dosing column, the goal is still to fill it to the brim. The operator may thus check at a glance whether the dosing columns are either filled or not. This self-control may be checked at a glance for the 100 dosing columns for example, which represents a considerable gain in time in the filling process. As compared with the prior art, this dosing system also gives a possibility of avoiding the risk of forgetting a dose in a staged compartment.

According to a possible configuration, said means for releasing the catalyst consist in a guillotine positioned under the dosing system and including a calibrated hole for each tube to be filled, said guillotine being able to slide between a closed position where the hole is shifted relatively to the corresponding dosing column and to the tube, and an open position where the hole is centered relatively to the corresponding dosing column and tube. This guillotine depending on its position therefore allows the catalyst present in the dosing column to be contained or to be released. It is possible to provide a set of guillotines with a different calibration of the holes according to the average diameter of the catalyst particles to be loaded. For the filling of n tubes, the guillotine consists in a single plate positioned under the dosing system and pierced with n holes corresponding to the arrangement of the n dosing columns and of the n tubes, n being an integer. The pouring of the catalyst may thus be carried out simultaneously in the n tubes. For example, depending on the machine, 100 tubes may be simultaneously loaded by means of a single device for which the bulk on the ground is contained in the space on the ground defined by the 100 tubes. This device is therefore compact in addition to being fast and efficient.

Optionally, the sliding of the guillotine is actuated by pneumatic driving means of the cylinder actuator type. However, such a guillotine may quite be actuated manually.

Advantageously, the means for recovering the dust consists in:
orifices for recovering dust made in the guillotine at the perimeter of each calibrated hole:
a dust suction compartment localized under the guillotine and comprising, for each hole, an intermediate sleeve placed between the dosing column and the tube and provided with a slot for discharging dust, and an air flow system between the sleeves with at least one fresh air intake and at least one outlet for foul air sucked by the suction means.

Indeed, when the guillotine is in an open position, the catalyst stored in the dosing column passes through the calibrated hole of the guillotine and then through the intermediate sleeve before arriving into the tube. A bottleneck is located at the calibrated hole of the guillotine, since it is chamfered and its diameter is slightly less than that of the dosing column in order to limit the passage to one granule at a time. Consequently, the perimeter of the calibrated hole is an impact area where the catalyst bounces, thereby forming dust which is discharged via said recovery orifices towards the suction compartment. This dust falls all around the intermediate sleeves, in the suction compartment, and is sucked up via suction means of the vacuum cleaner pipe type connected to the air outlet. The slot for recovering dust in the intermediate sleeve is provided for discharging the dust present within the sleeve. The guillotine may be coated with a damping lining for limiting at most a possible degradation of the catalyst. Generally, it is primordial to suck up this dust formed at the mobile device in order to protect the operators working nearby. By being almost free of dust, the quality of the loading is considerably improved.

Moreover, the mobile device includes means for recovering the excess catalyst in the storage trough before pouring it into the tubes. The recovery means consist in:
a hatch provided in one of the walls of the storage trough, capable of opening for discharging the excess catalyst;
a pouring spout positioned at the outlet of the hatch;
a recovery trough receiving the excess catalyst via said pouring spout.

The thereby recovered catalyst may be reused during the next loading.

Practically, the mobile device consists of a chassis supporting the storage trough_{;} the dosing system, the means for releasing the doses and the suction compartment, said chassis being laid on a Silentbloc shock absorber and shaken by means of at least one vibrator.

The mobile device cooperates with a centering plate positioned on the area where the tubes to be filled are found, said plate including:
centering bushings extending perpendicularly to the plate and able to be inserted into the upper aperture of the corresponding tubes;
at least one positioning abutment of the mobile device relatively to the plate in order to centre the dosing system relatively to the tubes.

This plate is placed beforehand on the tubes and therefore gives the possibility of visually defining the area to be loaded for the operator. The latter then moves the mobile device towards this plate, and is aware when it is properly positioned above it when the Silentbloc shock absorber comes into contact with the positioning abutment, thereby limiting the displacement of the mobile device. As a conclusion, the mobile filling device does not include any invasive element which would penetrate into a tube during its positioning and its loading, so as to guarantee a minimum bulk of the machine within the reactor.

The present invention also relates to a method for loading a catalyst into a reactor with several tubes comprising the following steps:
positioning a mobile filling device, as described above, on a centering plate positioned on the reactor with centering of each dosing column of the device with respect to a corresponding tube;
loading the catalyst in a storage trough located in the upper portion of the filling device and the bottom of which comprises holes opening into the dosing columns;
filling the catalyst in the dosing column(s) until it is flush with the bottom of the storage trough;
discharging the excess catalyst present in the storage trough towards a recovery trough;
opening a guillotine letting through the catalyst dose present in each dosing column towards the corresponding tube;
starting vibration of the filling device;
stopping the vibration and closing the guillotine;
repetition of the steps for loading, filling, discharge, opening the guillotine, starting the vibration, stopping the vibration and closing the guillotine, depending on the filling volume required per tube.

After this loading, conventional control steps such as gauging and plugging, are carried out.

Since only the loaded tubes have to be gauged, it is possible to use a multitude of dipsticks simultaneously, the global imprint of the dipsticks corresponding to that of the filling machine used.

### DESCRIPTION OF A PREFERENTIAL EXAMPLE ILLUSTRATED IN THE FIGURES The invention will now be described in more detail, with reference to the appended figures, for which:

FIG. 1 is a sectional view of the mobile device according to the invention;

FIG. 2 is a view of the mobile device which details the junction between the dosing system, the suction system and the tubes;

FIG. 3 is a top view of the mobile filling device;

FIG. 4 is a front view of the mobile filling device;

FIGS. 5 to 8 show the different steps of the positioning of the mobile filling device above the tubes of the reactor;

FIGS. 9 to 16 illustrate the different steps of a method for loading tubes of the reactor;

FIG. 17 illustrates another alternative of a mobile filling device according to the invention.

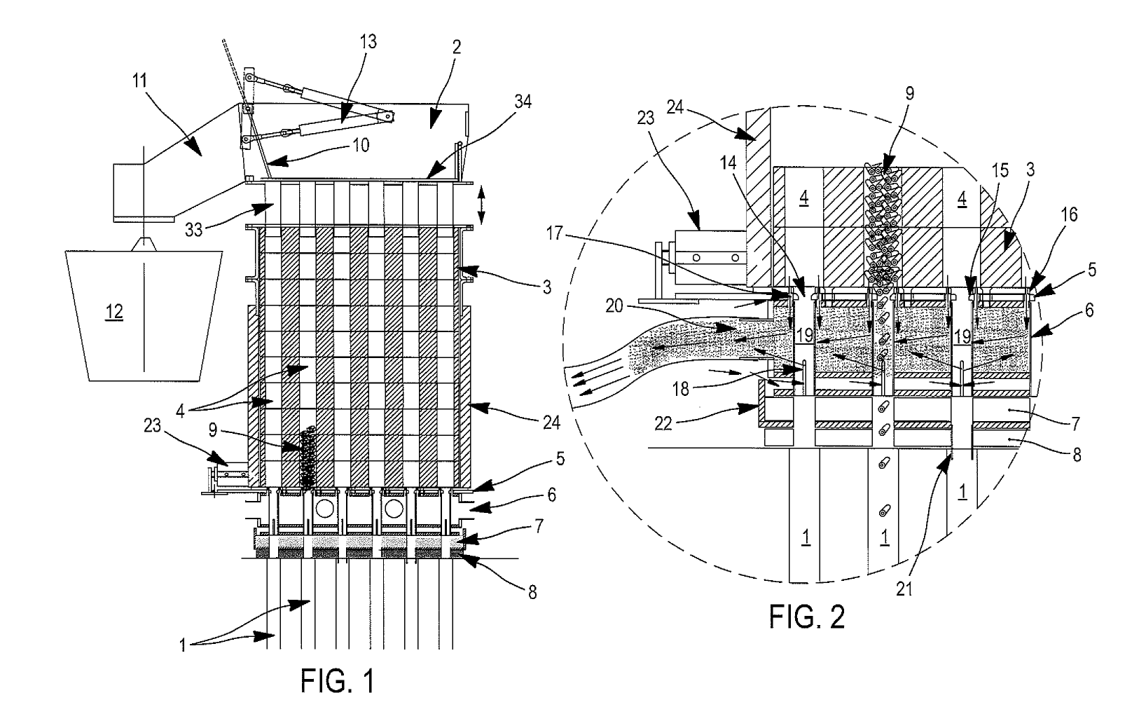

According to FIG. 1, the mobile filling device consists in a chassis (24) with a parallelepipedal aspect supporting various elements. These elements more particularly consist in a catalyst (9) storage trough (2) positioned in the upper portion of the mobile device and surmounting a dosing system (3) consisting of dosing columns (4) under which is found a guillotine (5) giving the possibility of opening or closing the bottom of the dosing columns (4) in order to either let through or not the catalyst (9) through a suction compartment (6), a Silentbloc shock absorber (7) and a centering plate (8), before arriving into the tubes (1) of the reactor.

The storage trough (2) into which the operator pours the catalyst (9) is provided with a sieve-shaped bottom (34), the orifices of which correspond to the apertures of the dosing columns (4) of the dosing system (3). Once the columns (4) are filled with the catalyst (9) flush with the sieve (34), the operator may remove the excess catalyst (9) present in the storage trough (2) by opening a hatch (10) corresponding to a side wall of the storage trough (2) by means of a mechanical system with small connecting rods (13) which allows the hatch (10) to be lifted. The operator may thus push the excess catalyst out of the storage trough (2). This excess catalyst (9) arrives into a pouring spout (11) with a shape of a funnel and then is poured into a bucket (12) being used as a trough for recovering catalyst (9). Once the dosing columns (4) are well filled and the excess catalyst (9) has been discharged, the operator may close the hatch (10).

Depending on the desired volume of catalyst (9) within the dosing columns (4), the operator may adjust the height of the columns (4) by means of a sliding system where sleeves (33), opening into the upper portion at the sieve and into the lower portion in the dosing columns, may be more or less inserted into the dosing columns in order to modify the loading height thereof as illustrated by the double arrow in FIG. 1. Once the dosing columns (4) are filled, the operator may pour the catalyst (9) into the tubs (1) of the reactor. This step is more specifically illustrated in FIG. 2,

The dosing system (3) may preferably consist in a neoprene block or in any other material having damping properties, within which piercings are made corresponding to the dosing columns (4). It rests on a stainless steel plate (16) attached to the chassis (24) and provided with holes matching the dosing columns (4). Under this plate (16) is found a guillotine (5) it also corresponding to a plate provided with calibrated holes (14) positioned in a centered way with the holes of the plate (16) and the dosing columns (4). This guillotine (5) has the particularity of being slidable by means of a pneumatic actuator (23) and may be moved between a first position where the plate closes the bottom of the dosing columns (4) and an open position where the calibrated holes (14) open the bottom of the dosing columns (4) in order to release the catalyst (9). The guillotine (5) is in an open position in Fig, 2.

Generally, the accumulation and the pouring of the catalyst (9) from the dosing columns (4) to the tubes (1) generate catalyst dust which tends to be volatilized in the ambient air surrounding the mobile device and of polluting the tubes (1). Now, this dust is noxious for operators working nearby and who may breathe it. Therefore, a suction compartment (6) is provided between the guillotine (5) and the tubes (1). This suction compartment (6) includes intermediate sleeves (19) positioned under the dosing columns (4) so that the catalyst (9) may be poured via these sleeves (19) into the tubes (1). Each sleeve (19) is provided with an actual slot (18) through which the dust may flow out and thus circulate around the sleeves (19). An airflow system (symbolized by the arrows in FIG. 2) is provided between these sleeves (19) with air intakes and an air outlet (20) on which may be plugged a suction pipe in order to suck up all the accumulated dusts around the sleeves (19).

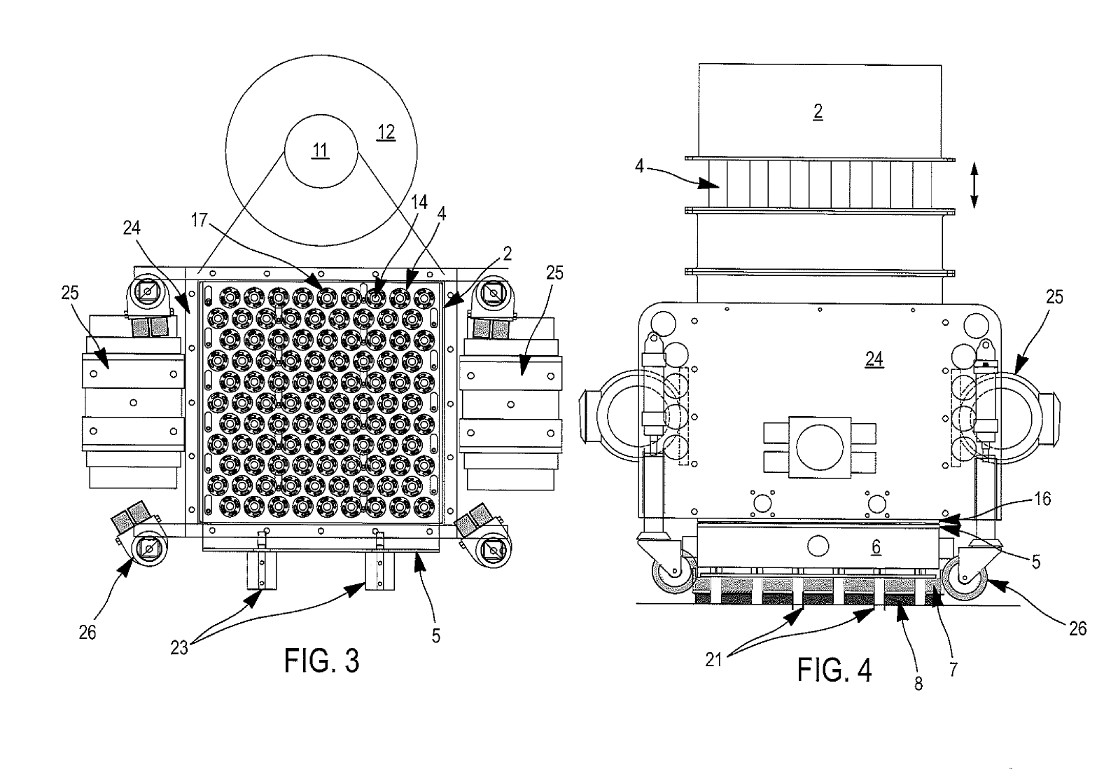

Further, the holes of the plate (16) and the calibrated holes (14) of the guillotine (5) have a diameter of less than the one of the dosing column (4), which means that the catalyst (9) will bounce on the plate (16) and on the chamfered edges (15) of the calibrated holes (14) of the guillotine (5). These impacts also generate catalyst dust, this is why orifices (17) for recovering dust are provided all around the calibrated holes (14) in the guillotine (5) (see FIG. 3), and the same applies around the holes in the plate (16). Thus, the catalyst dust may easily pass through the dust recovery orifices (17) and directly arrive into the area of the suction compartment so as to be sucked up. The guillotine (5) may be coated with lining so as to minimize the impacts with the catalyst (9).

In order to facilitate the pouring of the catalyst (9) into the tubes (1), the mobile filling device is provided with two vibrators (25) located on two opposite faces of the chassis (24) as illustrated in FIG. 3. These vibrators (25) not only allow acceleration of the loading process but also separation of the catalyst clusters (9) so that they more easily pass via the calibrated holes (14) and the sleeves (19) before arriving into the tubes (1). In order to limit the deformations of the chassis (24) during these vibrations, it is provided that the chassis (24) is positioned on a Silentbloc shock absorber (7) localized under the suction compartment (6) as this is visible in FIG. 4. Finally, in order that the mobile filling device be easily displaceable, four castors (26) are provided, positioned at the four corners of the chassis. In this way, an operator may by himself/herself displace the mobile device at his/her convenience above the areas to be filled on the reactor.

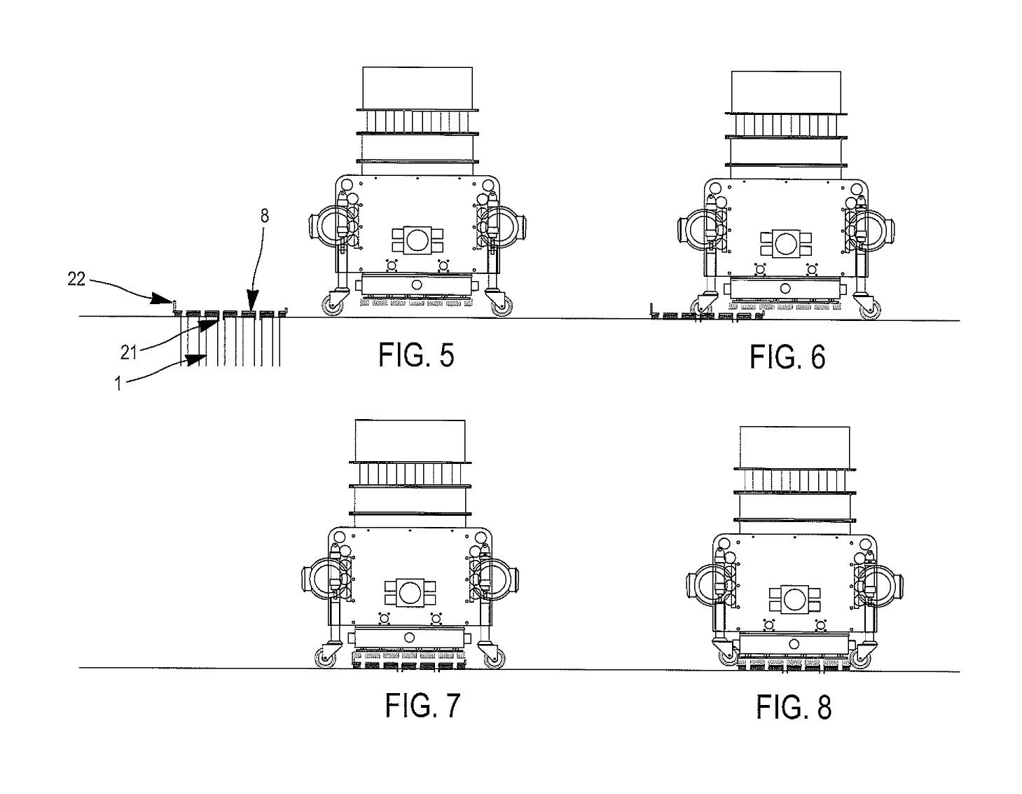

As this is illustrated in FIGS. 5 to 8, an operator may move the mobile device by means of castors (26). In order that the dosing columns (4) be actually well centred on the tubes (1), a centring plate (8) is provided which the operator will first lay on the area to be filled at the surface of the reactor. Practically, this is a plate (8) provided with centring bushings (21) able to penetrate in the upper portion of the tubes (1) in order to be well positioned on the tubes (1). This plate (8) includes orifices at each tube (1) and also includes a positioning abutment (22) of the mobile device,

In FIG. 5, the operator has properly positioned the plate (8) on the area of the reactor to be filled, the mobile carriage being positioned nearby.

In FIG. 6, the operator moves the carriage and makes it roll above the centering plate (8) until the Silentbloc shock absorber (7) will abut against the positioning abutment (22) of the plate (8) as this is illustrated in FIG. 7. The carriage is then positioned above the tubes (1).

The operator may then lower the mobile device so that it will bear against the centering plate (8) and move up again the castors (26). In FIG. 8, the mobile device is thus properly positioned above the tubes and the loading process may start,

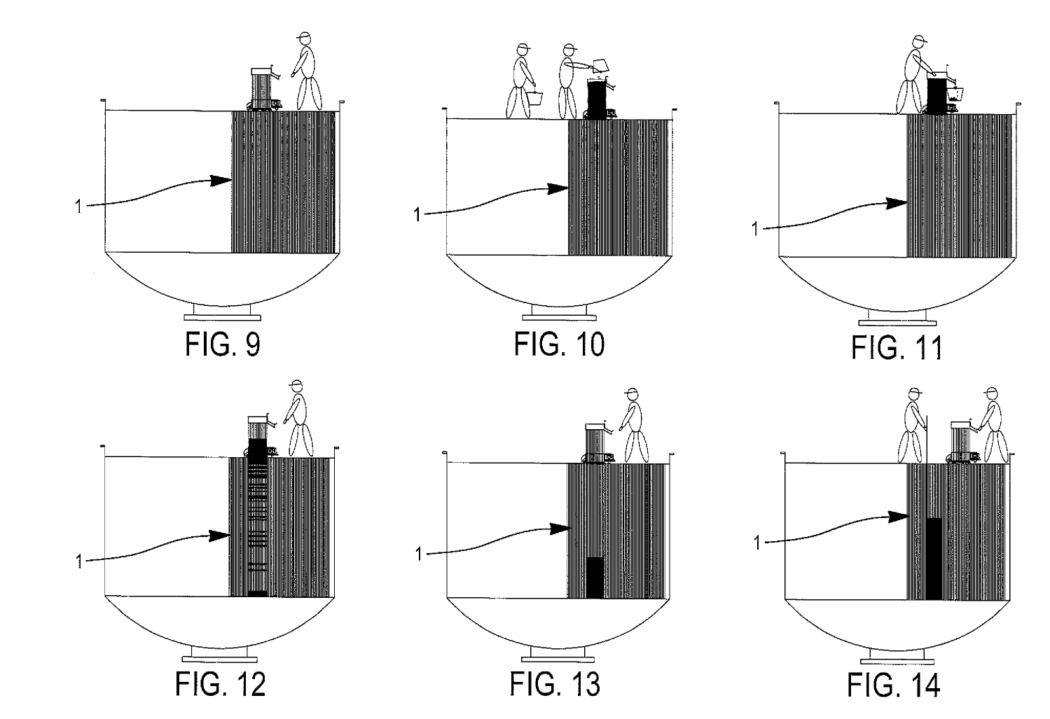

The first step of this process is illustrated in FIG. 9 where the mobile filling device is properly positioned above the tubes (1) of a reactor.

In FIG. 10, the operator will pour some catalyst into the storage trough and will spread it in the dosing columns until they are well filled, the guillotine being in a closed position.

In FIG. 11, the operator discharges the catalyst excess towards the recovery trough so that the catalyst is flush with the bottom of the storage trough.

In FIG. 12, the operator starts the vibrators of the mobile device and opens the guillotine in order to let through the catalyst into the tubes of the reactor.

In FIG. 13, the tubes are filled with a first loading height. Depending on the desired height, the operator repeats the operations illustrated in FIGS. 10, 11 and 12 until the desired height is obtained in the loading tubes.

In FIG. 14, once the desired height has been obtained, the operator removes the mobile device and will measure the filling height of each tube with a dipstick in order to check their proper loading.

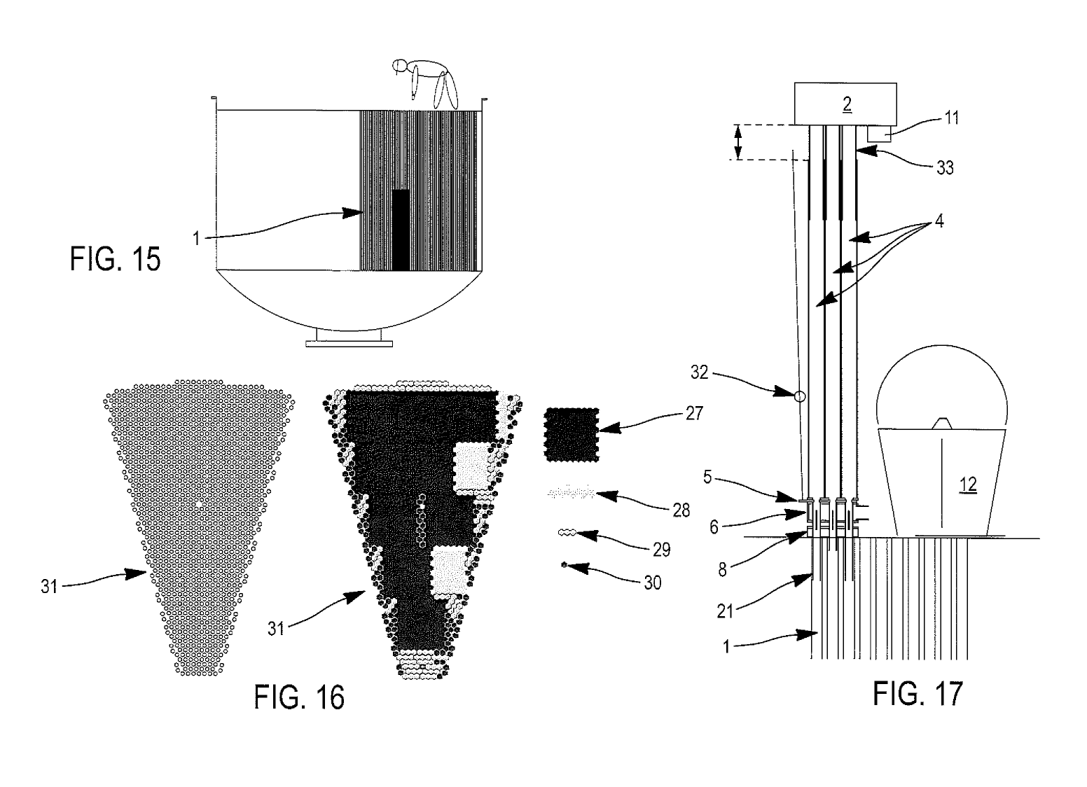

In FIG. 15, after having carried out this control step, the operator will plug the filled tubes with plugging plates, the dimension of which corresponds to the loaded area as illustrated in FIG. 16.

Because of the dimensions of the sectors to be loaded into a reactor, like a puzzle, certain areas are preferably filled by means of a mobile device for 100 tubes, or 20 tubes, or 3 tubes or a single tube, these areas being then identified by 100 tubes plugs (27), or 20 tubes plugs (28), or 3 tubes plugs (29) or unit plugs (30).

With this plugging system, the operator easily identifies the different areas of the reactor. A colour code may be set into place as a control step for the loading. For example, before the loading, the operator plugs the whole upper circular surface of the reactor with plugs of a first colour as a jigsaw, their shapes corresponding to the imprints of the different sizes of the loading machines. Next, for each plug, the operator replaces it with a centring plate and proceeds with the loading of the tubes located below. At the end of the loading, he/she replaces the sintering plate with a plug of a second color, meaning that the tubes are loaded but not checked. For the gauging step, the operator removes this plug, checks the loading height of catalyst with one or several dipsticks, rectifies the loading if need be, and then closes the loaded and checked tubes with a plug of a third color. Thus, depending on the color of the plugs, the operator is aware if the tubes located below are empty, or loaded and non-validated, or loaded and validated.

FIG. 17 illustrates a mobile filling device for three tubes. This mobile device resumes the same design as the mobile device described earlier and comprises the same elements, i.e. a catalyst storage trough (2), dosing columns (4), a system for adjusting in height the dosing columns via sleeves (33), a guillotine (5) positioned under the dosing columns (4), a suction compartment (6) with its intermediate sleeves and a centering plate (8) with its centering bushings (21) penetrating into the tubes (1). As this device is only provided for two tubes, the guillotine may for example be manually actuated via a mechanism (32). In the same way, it is possible to provide mobile devices for a whole other number of tubes for example 17, 40, 120 etc. . . . depending on the needs of the reactors.

The configurations shown in the mentioned figures are only possible, by no means limiting examples of the invention which on the contrary encompasses alternatives of shapes and designs within the reach of one skilled in the art.

1. A mobile filling device capable of filling at least one tube of a catalytic reactor consisting of a plurality of tubes with a parallel aspect filled with a catalyst found in granular form,
this device comprising:
a storage trough of catalyst with a sieve-shaped bottom each hole of which is capable of coinciding with a tube of the reactor;
a dosing system of catalyst for each tube to be filled, corresponding to a dosing column able to be centered relatively to the tube and receiving a predetermined volume of catalyst;
means for simultaneously releasing the catalyst contained in the dosing system towards the tube(s) to be filled;
wherein it has means for recovering the dust formed by the pouring of the catalyst into the tubes.

2. The mobile device for filling at least one tube of a catalytic reactor according to claim 1, wherein said means for releasing the catalyst consist in a guillotine positioned under the dosing system and including a calibrated hole for each tube to be filled, said guillotine being able to slide between a closed position where the hole is shifted relatively to the corresponding dosing column and to the tube, and an open position where the hole is centred relatively to the corresponding dosing column and to the tube.

3. The mobile device for filling at least one tube of a catalytic reactor according to claim 2, wherein said dust recovery means consist in:
orifices for recovering dust made in the guillotine at the perimeter of each calibrated hole;
a compartment for dust suction localized under the guillotine and comprising, for each hole, an intermediate sleeve placed between the dosing column and the tube and provided with a slot for discharging dust, and an air flow system between the sleeves with at least one intake of fresh air and at least one outlet of foul air sucked by the suction means.

4. The mobile device for filling at least one tube of a catalytic reactor reactor according to claim 2, wherein, for filling n tubes, the guillotine consist in a single plate positioned under the dosing system and pierced with n holes corresponding to the arrangement of the n dosing columns and of the n tubes, n being an integer.

5. The mobile device for filling at least one tube of a catalytic reactor according to claim 2, wherein the sliding of the guillotine is actuated by driving means of the actuator type.

6. The mobile device for filling at least one tube of a catalytic reactor according to claim 1, wherein it comprises means for adjusting in height the dosing column according to the catalyst volume to be dosed.

7. The mobile device for filling at least one tube of a catalytic reactor according to claim 1, wherein it includes means for recovering the excess catalyst in the storage trough before pouring into the tubes.

8. The mobile device for filling at least one tube of a catalytic reactor according to claim 7, wherein said recovery means consist:
in a hatch provided in one of the walls of the storage trough, capable of opening for discharging the excess catalyst;
a pouring spout positioned at the outlet of the hatch;
a recovery trough receiving the excess catalyst via said pouring spout.

9. The mobile device for filling at least one tube of a catalytic reactor according to claim 8, wherein it consists of a chassis supporting the storage trough, the dosing system, the means for releasing doses and the suction compartment, said chassis being laid on the Silentbloc shock absorber and shaken by means of at least one vibrator.

10. A system for filling at least one tube of a catalytic reactor with a mobile device according to claim 1, wherein the mobile device cooperates with a centering plate positioned on the area where the tubes to be filled are found, said plate including:
centering bushings extending perpendicularly to the plate and capable of being inserted into the upper aperture of the corresponding tubes;
at least one positioning abutment of the mobile device relatively to the plate with view to centering the dosing system relatively to the tubes.

11. A method for loading catalyst into a reactor with several tubes comprising the following steps:
positioning a mobile filling device, as described in claim 1, on a centering plate positioned on the reactor with centering of each dosing columns of the device relatively to a corresponding tube;
loading the catalyst into a storage trough located in the upper portion of the filling device and the bottom of which comprises holes opening into the dosing columns;
filling the catalyst into the dosing column(s) until it is flush with the bottom of the storage trough;
discharging the excess catalyst present in the storage trough towards a recovery trough;
opening a guillotine letting through the catalyst dose present in each dosing column towards the corresponding tube;
starting the vibration of the filling device;
stopping the vibration and closing the guillotine;
repeating steps for loading, filling, discharging, opening the guillotine, starting vibration, stopping the vibration and closing the guillotine, according to the filling volume required per tube.
